(19) United States
(12) Patent Application Publication
(10) Pub. No.: US 2011/0090134 A1
(43) Pub. Date: Apr. 21, 2011

(54) PARTIAL DISCHARGE DETECTOR

(75) Inventors: Ryoichi Shinohara, Hitachi (JP); Ryo Koyama, Hitachi (JP)

(73) Assignee: JAPAN AE POWER SYSTEMS CORPORATION, Tokyo (JP)

(21) Appl. No.: 12/994,384

(22) PCT Filed: Apr. 21, 2009
(86) PCT No.: PCT/JP2009/058238

§ 371 Date: Nov. 23, 2010

(30) Foreign Application Priority Data
May 29, 2008 (JP) 2008-140223

(51) Int. Cl. H01Q 1/12

(52) U.S. Cl. 343/892

(57) ABSTRACT

Flanges 1A, 2A of metal containers 1, 2 are connected by a plurality of stud bolts 4 through an insulating spacer 3. An antenna body 10 having a planar antenna 11 and an insulating cover 12 is mounted at least on the outer peripheral surface of the insulating spacer 3. In the antenna body 10, an L-shaped support plate 13 is secured on the upper surface of the antenna body 10. And, the support plate 13 is fixed to a mounting plate 15 and a connecting means 16. Or the support plate 13 is fixed directly to the stud bolts 4.

### TECHNICAL FIELD

The present invention relates to a partial discharge detector particularly to such a partial discharge detector that is for use in insulation diagnosis of electrical apparatuses by detecting partial discharge that occurs in a closed metal container like a gas-insulated electrical equipment.

### BACKGROUND ART

In a gas-insulated switchgear (hereinafter referred to as GIS), which is a gas-insulated electrical equipment of which main constituents such as switching sections and current-carrying conductors are housed in a closed metal container filled with insulation gas, the insulation state of the GIS is decided by detecting partial discharge occurring inside the metal container using a partial discharge detector as a common practice.

A partial discharge detector is mounted in the GIS in such a manner as is described in JP 10-51917 A1 (Patent Literature 1) for example, wherein a rectangular antenna body, which is a planar antenna of a thin conductive plate enveloped with an insulation sheet of flexible resin, is mounted at least on the outer peripheral surface of an insulating spacer that supports a current-carrying conductor. The detecting device is operated being connected to the antenna body through a signal detector cable.

The partial discharge detector decides abnormality in a manner in which the antenna body receives a radio signal, which partial discharge generates, passed through the insulating spacer and a detecting device decides abnormality based on the received radio signal.

The partial discharge detector defined in Patent Literature 1 uses a flexible antenna body. This permits eased mounting the antenna body on the outer peripheral surface of an insulating spacer even though the curvature of the outer periphery is in variety.

In the partial discharge detector of Patent Literature 1 however, there is a concern that the partial discharge detector mounted in GIS may fall off from the outer peripheral surface of the insulating spacer if certain external force acts on the signal detector cable during a long-time operation for monitoring partial discharge. Further, there is an anxiety about problems such as occurrence of wiring break at the connection between the antenna body and the signal detector cable by an external force.

Under these circumstances, it has been desired that a partial discharge detector for GIS should have such a structure that it hardly falls off even when external force acts on such as the signal detector cable when being mounted on the insulating spacer and thereby abnormality will little occur in the signal transmission system assuring stable signal transmission over a long period of time.

It has been also desired that mounting the partial discharge detector on GIS should demand no special manufacture on GIS side and should require minimized additional work to a practicable extent.

An object of the present invention is to provide a partial discharge detector which is easily installed, which has no possibility to fall off even if external force acts on a signal detecting cable or the like, and which is capable of stably transmitting a signal over a long period of time.

### DISCLOSURE OF INVENTION

A partial discharge detector by the present invention has such a construction that a plurality of stud bolts; an insulating spacer; flanges of metal containers are connected by the plurality of stud bolts through the insulating spacer; and an antenna body having a planar antenna and an insulating cover, the antenna body being mounted at least on the outer peripheral surface of the insulating spacer in a manner, in which an L-shaped support plate is secured on the upper surface of the antenna body, a free end of the L-shaped support plate is bent upward, the L-shaped support plate is secured to the stud bolt with a mounting plate placed between the free end of the L-shaped support plate and the stud bolt, the mounting plate having an elongated hole.

Also a partial discharge detector by the present invention has such a construction that a plurality of stud bolts; an insulating spacer; flanges of metal containers are connected by the plurality of stud bolts through the insulating spacer; and an antenna body having a planar antenna and an insulating cover, the antenna body being mounted at least on the outer peripheral surface of the insulating spacer in a manner, in which an L-shaped support plate is secured on the upper surface of the antenna body, a free end of the L-shaped support plate is extended to the face of the flange, and the free end of the L-shaped support plate is secured by the stud bolt.

Preferably, the partial discharge detector should have such a construction that wherein the planer antenna connects with a connector electrically, and the connector is installed on the support plate secured on the antenna body.

### EFFECT OF INVENTION

Configuring a partial discharge detector as defined in the present invention makes the installation of the partial discharge detector on GIS easy and eliminates a possibility of the falling off of the partial discharge detector even if an external force acts on the signal transmission cable. Further, there is an advantage in that reliability can be improved because a partial discharge detector can pick up a signal stably over a long period of time.

### BRIEF DESCRIPTION OF DRAWINGS

FIG. 1 is a schematic plane view to illustrate the partial discharge detector as an example of embodiment of the present invention.

FIG. 2 is a schematic vertical sectional view of the object in FIG. 1 sectioned along the line A-A in FIG. 1.

FIG. 3 is a detail view of the portion B in FIG. 2.

FIG. 4 is a side view of the object in FIG. 1.

FIG. 5 is a side view of the object in FIG. 1 viewed from right side.

FIG. 6 is a schematic vertical sectional view of the partial discharge detector as another example of embodiment of the present invention.

### BEST MODE FOR CARRYING OUT INVENTION

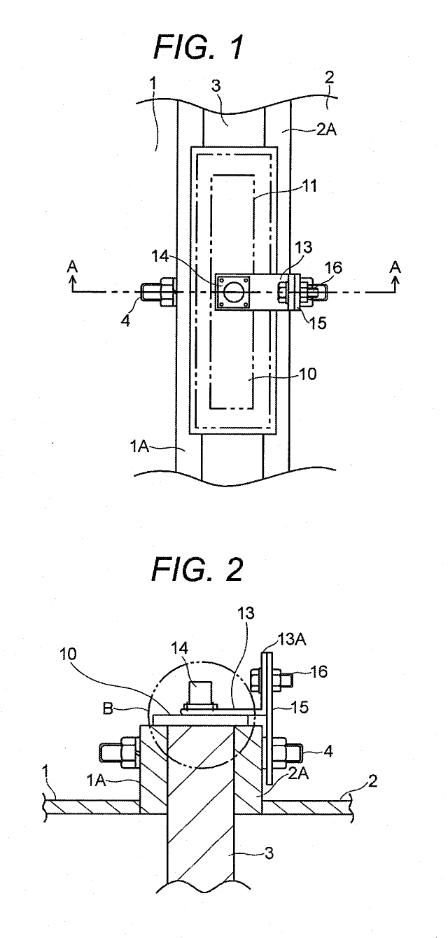

A partial discharge detector by the present invention has such a construction that flanges of metal containers are connected by a plurality of stud bolts through an insulating spacer; and an antenna body consisting of a planar antenna and an insulating cover is mounted at least on the outer peripheral surface of the insulating spacer. On the upper surface the antenna body, an L-shaped support plate is secured; the support plate is fixed by the stud bolt. Hereunder, explanation of the partial discharge detector by the present invention will follow referring to FIGS. 1 to 5.

### Embodiment 1

FIG. 1 and FIG. 2 illustrate a status in which flanges 1A and 2A respectively of metal containers 1 and 2 are connected by a plurality of stud bolts 4 through an insulating spacer 3 interposed between the flanges 1A and 2A; and an antenna body 10 to be used for a partial discharge detector is mounted over the outer peripheral surface of an insulating spacer 3 and the flanges 1A and 2A to which the insulating spacer 3 adjoins.

The antenna body 10 illustrated in FIG. 1 and FIG. 2 is broader than the width of the insulating spacer 3; therefore, the lateral edges of the antenna body 10 extend to the outer peripheral surfaces of the flanges 1A and 2A. However, it is enough that the antenna body 10 is installed at least the outer peripheral surface of the insulating spacer 3, since the antenna body 10 of the partial discharge detector detects partial discharge through the insulating spacer 3 occurred inside the metal container.

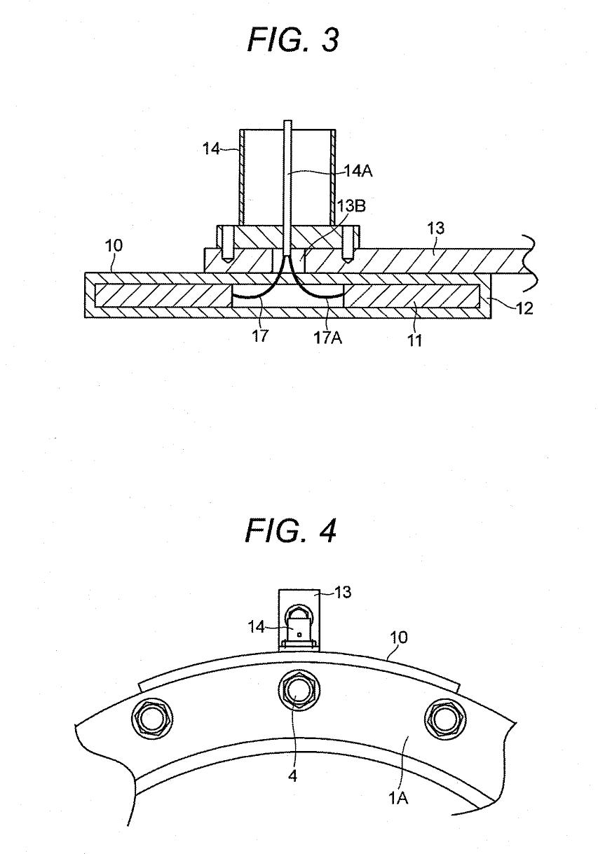

The antenna body 10, the main part of the partial discharge detector has a conductive planar antenna 11 and an insulating cover 12 of flexible resin film that covers the planer antenna 11, as illustrated in FIG. 3. On the upper surface of the antenna body 10, an L-shaped support plate 13 is glued; on the upper surface of the support plate 13, a connector 14 is screwed.

The connector 14 and a connection pin 14A arranged coaxially with the connector 14 are electrically connected with the planar antenna 11 via connecting wires 17 and 17A that pass a through hole 13B permitting connection with a detecting device (not shown) through a signal transmission cable (not shown).

In the example illustrated in FIG. 1 and FIG. 2, the support plate 13 is arranged approximately in the longitudinal middle of the antenna body 10 and perpendicular to the lengthwise direction thereof with a free end of the support plate 13 bent upward at right angles.

A free end 13A of the support plate 13 bent upward is secured on a mounting plate 15 with a removable connecting means 16 such as bolts and nuts. The mounting plate 15 is secured on the flange 2A using the stud bolt that connects the flanges 1A and 2A of the metal containers 1 and 2 of GIS.

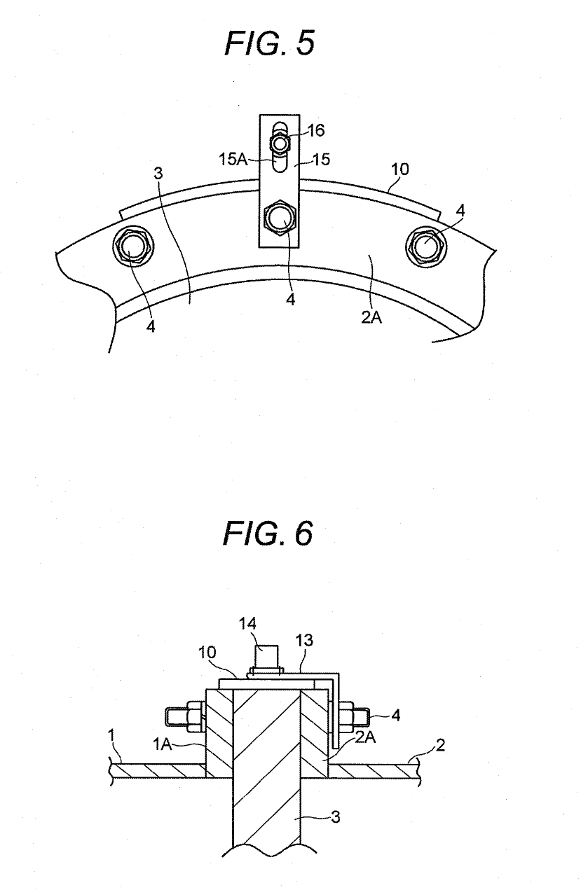

Installing the antenna body 10 is performed in a manner, in which the antenna body 10 is secured on the arc-shaped area of the outer peripheral surface of such as the insulating spacer 3 as illustrated in FIGS. 4 and 5. This means that the antenna body 10 is stuck on the outer peripheral surface of the flanges 1A and 2A and the insulating spacer 3 with a minimized interstice therebetween applying, for example, a double-sided adhesive tape on the bottom face of the antenna body 10. And then, the support plate 13 secured on the upper surface of the antenna body 10 is removably fastened on the mounting plate 15 fixed to the stud bolt 4 with the connecting means 16.

The mounting plate 15 is for fixing the support plate 13 on the flange 2A to install the antenna body 10 on the outer peripheral surface of the insulating spacer having different dimensions. In this arrangement, providing an elongated hole 15A on the mounting plate 15 as illustrated in FIG. 5 permits the support plate 13 to use the hole in its positioning in the radial direction of the insulating spacer 3.

The diameters of metal containers 1 and 2 of a GIS become larger depending on the voltage rating of main circuit thereof causing the diameter of the insulating spacer 3 being increased. Even if the curvature of the outer peripheral surface of the insulating spacer 3 changes, the antenna body 10 can be stuck without interstice since the antenna body 10 is flexible.

Under the condition in which the antenna body 10 is stuck at least on the outer peripheral surface of the insulating spacer 3 of a GIS, the antenna body 10 cannot fall off from the insulating spacer 3 even if an external force acts on the signal transmission cable, since the connector 14 is mechanically and firmly fastened on the support plate 13. Further, no wire break problem will occur in the connecting wires 17 and 17A for signal transmission since the external force does not act thereon. Further more, the mounting plate 15 can be fixed using the stud bolt 4 that is for tightening the flanges 1A and 2A mutually; therefore, no special manufacture is required to install the antenna body 10 with the workability improved.

### Embodiment 2

Illustrated in FIG. 6 is another embodiment of the present invention, wherein the L-shaped supporting plate is given arrangement different from the one illustrated in FIG. 2; features other than this are same as those in the previous description. The support plate 13 illustrated in FIG. 6 is used in a manner wherein the support plate 13 is arranged so that its free end of the L-shape portion will extend to the surface of the flange 2A and the extended portion of the free end is directly fastened on the face of a flange 2A by the stud bolt 4; thereby the antenna body 10 is secured directly on the outer peripheral surface of the insulating spacer 3.

In fastening the free end of the support plate 13 directly on the surface of the flange 2A, an elongated hole provided on the free end portion of the L-shape is used for aligning fastening position. With this configuration, the support plate 13 can be fastened easily on the surface of the flange 2A by the stud bolt 4 without use of the mounting plate 15 or the connecting means 16.

### INDUSTRIAL APPLICABILITY

The partial discharge detector by the present invention is applicable without difficulty to a gas-insulated electrical equipment such as a gas-insulated switchgear, which uses gas-filled insulation, and improves reliability of the partial discharge detector.

1. A partial discharge detector comprising:
a plurality of stud bolts;
an insulating spacer;
flanges of metal containers being connected by the plurality of stud bolts through the insulating spacer; and
an antenna body having a planar antenna and an insulating cover, the antenna body being mounted at least on the outer peripheral surface of the insulating spacer,
wherein an L-shaped support plate is secured on the upper surface of the antenna body,
a free end of the L-shaped support plate is bent upward, and
the L-shaped support plate is secured with the stud bolt with a mounting plate placed between the free end of the L-shaped support plate and the stud bolt, the mounting plate having an elongated hole.

2. A partial discharge detector comprising:
a plurality of stud bolts;
an insulating spacer;
flanges of metal containers being connected by the plurality of stud bolts through the insulating spacer; and
an antenna body having a planar antenna and an insulating cover, the antenna body being mounted at least on the outer peripheral surface of the insulating spacer,
wherein the L-shaped support plate is secured on the upper surface of the antenna body,
a free end of the L-shaped support plate is extended to the face of the flange, and
the free end of the L-shaped support plate is secured by the stud bolt.

3. The partial discharge detector according to claim 1, wherein the planer antenna connects with a connector electrically, and the connector is installed on the support plate secured on the antenna body.
